(19) United States
(12) Patent Application Publication
(10) Pub. No.: US 2010/0059593 A1
(43) Pub. Date: Mar. 11, 2010

(54) STORED VALUE CARD JACKET AND COUNTER

(76) Inventor: Dominic DeFranco, Staten Island, NY (US)

Correspondence Address: GIBSON & DERNIER LLP, 900 ROUTE 9 NORTH, SUITE 504, WOODBRIDGE, NJ, 07095, US

(21) Appl. No.: 12/552,730

(22) Filed: Sep. 2, 2009

Related U.S. Application Data
(60) Provisional application No. 61/095,782, filed on Sep. 10, 2008.

(51) Int. Cl. G06K 7/00

(52) U.S. Cl. 235/486; 235/439; 235/492

(57) ABSTRACT

A stored value card jacket and counter device is disclosed that includes a jacket and a counter disposed on the jacket and functions to receive and protect a stored value card and to display information, through a counter display region, pertaining to the stored value card such as a monetary value, including the remaining balance, that is associated with the stored value card.

### APPLICATION DATA

This application claims benefit to U.S. Provisional Application No. 61/095,782 filed on Sep. 10, 2008, incorporated by reference in its entirety.

### TECHNICAL FIELD

The instant invention is related to a stored value card jacket and counter device that functions to protect a stored value card and to also display a monetary value, such as the remaining balance, in a display region that is associated with the stored value card.

### BACKGROUND OF THE INVENTION

A stored-value card represents money on deposit with the issuer, and is similar to a debit card. Debit cards are usually issued in the name of individual account holders, while stored value cards are usually anonymous. Examples of stored-value cards include transit fare cards, gift cards, phone cards, meal plan cards and pre-paid credit cards. A stored value card may often be used by simply swiping the card through a reader, such as in the case of transit cards. However, the remaining balance on the card may not be readily apparent to the user except at the time of swiping the card, where a digital readout from the point of sale shows the user the balance remaining. It is difficult for a user to remember exactly how much remains on the card, especially if the card is not used frequently.

Thus it would be useful to provide a device that allows a user to keep track of the balance of a stored value card or a debit card.

### SUMMARY OF THE INVENTION

In accordance with the present invention a stored value card holder device is provided that displays the remaining balance of a stored-value card or debit card held within the holder.

One embodiment of the present invention includes a jacket for a stored value card, and a counter operable to indicate the amount of value remaining on the stored value card. The jacket may include a top and bottom surface, a slot and an opening. The slot and opening of the jacket may be sized and shaped to receive an object, for example, a stored value card. The jacket may also be sized and shaped to receive only a portion of a stored value card such that a remaining portion, such as a portion including a magnetic strip, on the stored value card is exposed or otherwise accessible. In yet another embodiment the invention may include a jacket that is operable to permit a user of the card to swipe the stored value card through a reader without removing the jacket. In accordance with this and other embodiments, the jacket may not envelop the entire stored value card. In another embodiment the jacket is transparent in at least the region of the magnetic strip to be read by the reader.

The counter may be any type of counter such as but not limited to an analog or digital counter, automatic or manual, and may employ dials, slides, electronics or the like. As such the counter may include at least one counter display region having one or more openings that show indicia corresponding to a monetary value related to the stored value card. In one embodiment the counter may be disposed on the jacket at any suitable location.

In one or more embodiments the invention may include a hanger for receiving a lanyard, chain or the like, a clip for attaching the stored value card holder device to a wallet, credit card slot, a pocket or the like, and a cover to obscure the counter.

In still a further embodiment the invention may include a plurality of jackets, one or more of such jackets having a counter, such as but not limited to a plurality of jackets contained in a book or wallet form.

In yet another embodiment the invention may include a device where one or more stored value cards are permanently integrated with the device.

These and other objects of the present invention will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a top plan view of a stored value card jacket with a counter in accordance with an embodiment of the present invention;

FIG. 2 is a cross-sectional view taken along line A-A¹ of the stored value card jacket with a counter of FIG. 1 in accordance with an embodiment of the present invention;

FIG. 3 is a side view of a dial device for a counter in accordance with an embodiment of the present invention;

FIG. 4 is a top plan view of a stored value card jacket with a counter in accordance with an embodiment of the present invention;

FIG. 5 is a top plan view of a stored value card jacket with a counter in accordance with an embodiment of the present invention;

FIG. 6A is a top plan view of a stored value card jacket with a counter in accordance with an embodiment of the present invention;

FIG. 6B is a top plan view of the stored value card jacket of FIG. 6A with an example of a stored value card;

FIG. 7 is a bottom plan view of a stored value card jacket in accordance with an embodiment of the present invention;

FIG. 8 is a top plan view of a stored value card jacket with a counter and cover flap in accordance with an embodiment of the present invention;

FIG. 9 is a is top perspective view of a holder for containing a plurality of stored value card jackets in accordance with an embodiment of the present invention;

FIG. 10 is a top view of a holder for containing a plurality of stored value card jackets in accordance with an embodiment of the present invention; and

FIG. 11 is a side view of the holder of FIG. 10 containing a plurality of stored value card jackets with counters in accordance with an embodiment of the present invention.

### DETAILED DESCRIPTION OF THE PREFERRED EMBODIMENTS

In this document, for the purposes of explanation, specific numbers, materials and configurations are set forth in order to provide a thorough understanding of the invention. It will be apparent, however, to one having ordinary skill in the art, that the invention may be practiced without these specific details. In some instances, well known features may be omitted or simplified so as not to obscure the present invention. Furthermore, reference in the specification to “one embodiment” or “an embodiment” means that a particular feature, structure or characteristic described in connection with the embodiment is included in at least one embodiment of the invention. The appearance of the phrase “in an embodiment” in various places in the specification are not necessarily all referring to the same embodiment.

The stored value card holder devices in accordance with the present invention are described herein.

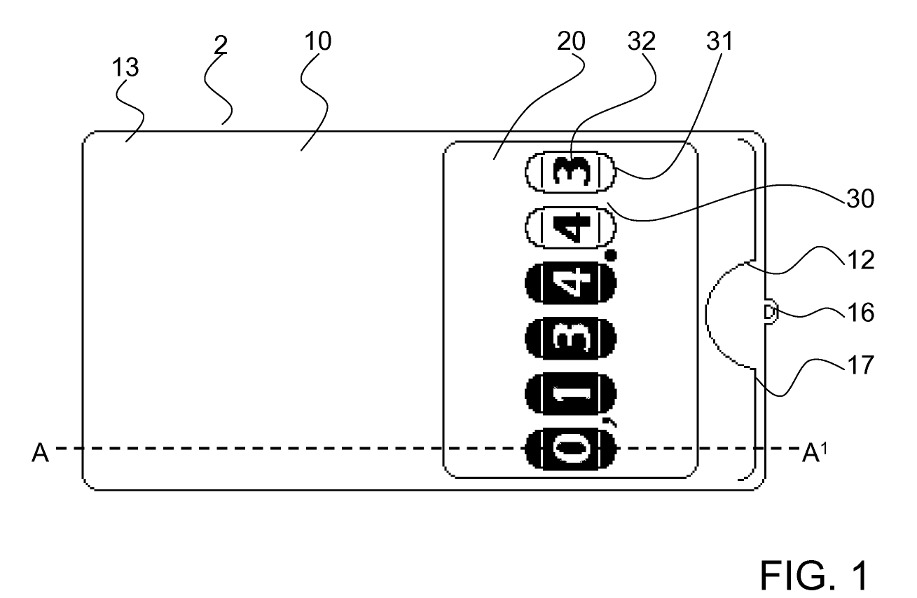

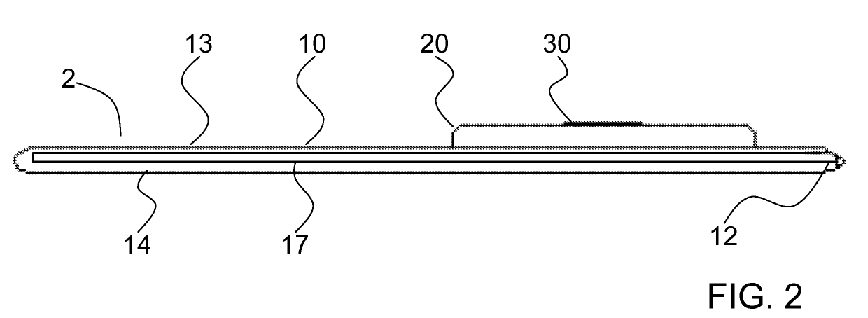

Now referring to FIGS. 1 and 2 in accordance with one embodiment a stored value card holder device 2 includes a stored value card jacket 10 and counter 20. The jacket 10 includes a top surface 13 and a bottom surface 14 that may be joined along their peripheries to form a slot 17. The jacket 10 may take the form of different shapes including a square, rectangle, trapezoid, circle, oval or curvilinear. Access to the slot 17 may be provided by an opening 12. The opening 12 may be formed and/or located in any suitable region of the jacket 10 for receiving an object that may fit in the slot 17. For example, as shown in FIG. 1, the opening 12 may be along the periphery of one side of the rectangular shaped jacket 10. The opening 12 is sized and shaped to receive an object that may fit in the slot 17, such as one or more stored value cards, debit cards, transit fare cards, gift cards, phone cards, meal plan cards, pre-paid credit cards or the like. The opening 12 may be shaped to allow easy access to the object inserted in the slot 17. For example, the opening 12 may be shaped with a cut-out that is sized to allow a user to drag his or her finger across the stored value card in order to push the stored value card out of the slot 17. The jacket 10 may be constructed of any suitable material such as but not limited to plastic, leather, cloth, rubber, silicone, metal or combinations thereof.

Typically the jacket 10 may be between about ¼ inch to 6 inches in length, ¼ inch to about 6 inches in width and have a thickness of between about 1/32 to about 5/32 of an inch so that the resulting slot 17 may accommodate any stored value card. One skilled in the art will recognize the jacket 10 may be sized and shaped to accommodate various objects, such as but not limited to a stored value card having the dimensions of about 3⅛ inches by 2⅛ inches, and about 1/32 inch in thickness.

In another embodiment the jacket 10 may further include a hanger 16 for receiving a lanyard, chain or the like.

The counter 20 includes a counter display region 30 and indicia 32. The counter display region 30 may areas 31 in which the indicia 32 may be viewed The counter 20 may be disposed on any suitable surface of the jacket 10. For example, the counter 20 may be disposed on the top surface 13 of the jacket 10, and may be so disposed and oriented in any suitable manner such as but not limited to formed integrally therewith, adhered, either permanently or temporarily, or the like. The counter 20 is preferably thin, or low profile, for example in the range of about 1/32 to about 4/32 of an inch in thickness, but it will be understood the thickness of the counter 20 may vary depending on the type of counter 20 employed and the particular application.

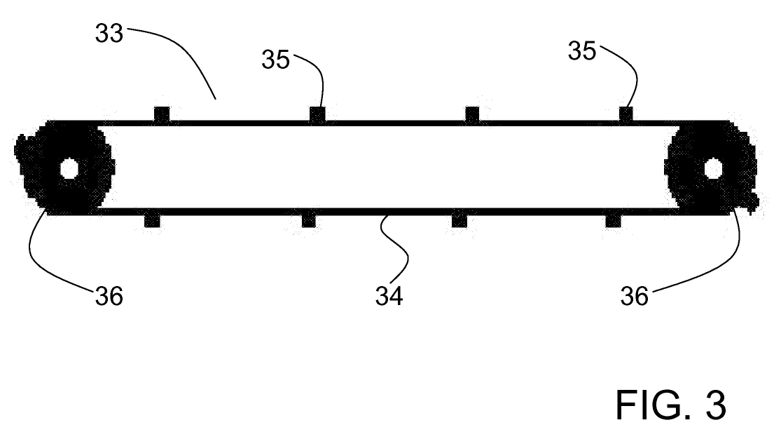

The counter 20 may be any type of counter useful for displaying indicia 32. Indicia 32 may be numbers, letters, characters, symbols or the like. For example, the counter 20 may display indicia 32 corresponding to a record or tally of the remaining monetary value on the stored value card and may be but is not limited to an analog or digital counter, electronic or manual, and may employ dials, slides or the like. As shown in FIG. 1, the counter 20 may include a counter display region 30 with six areas 31 through which indicia 32 may be viewed. Each of the indicia 32 may correspond to different denominations of monetary value, such as dollar and cent amounts. In this embodiment, areas 31 are openings as described further hereinbelow with reference to FIG. 3.

The indicia 32 may be presented through various means. Now referring also to FIG. 3, in one embodiment the indicia 32 may be presented as numbers on a dial 33. For example, a counter 20 may include a dial 33 underlying each opening 31, and a low profile endless tread member 34, optionally having tabs 35, upon which indicia 32 may be disposed. In one embodiment the indicia 32 may be monetary values, listed sequentially 0 to 9, corresponding to the remaining monetary balance on a stored value card. The tabs 35 may protrude slightly from the tread member 34 to facilitate ease of use by a user, who may “thumb” the tab 35 through the opening 31 to advance the dial 33. Each tread member 34 may be disposed on and travel over axles 36, and preferably be adapted to “click” into place with each passing number via a ratchet mechanism or other mechanism as is known in the art. The amount remaining on the stored value card may be preferably manually dialed in on the counter 20 by the user, however it will be recognized by the skilled artisan that one or more embodiments may include automatic balance updating at the point of sale or elsewhere.

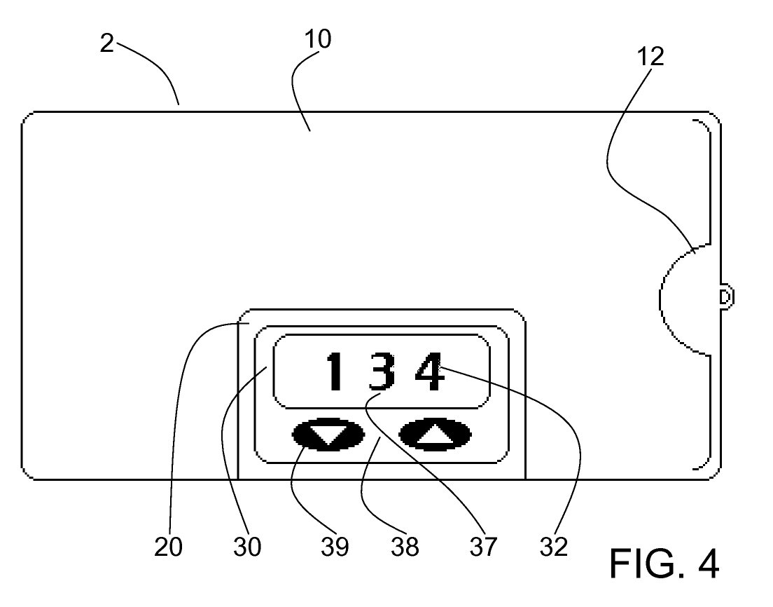

Now referring to FIG. 4, an alternate embodiment may include indicia 32 of the counter 20 in a display region 30 that is an electronic digital display 37. In this embodiment, the counter 20 further includes a keypad 38 having one more keypad buttons 39. The electronic digital display may be a liquid crystal display, a light emitted display or other electronic display as is known in the art. The indicia 32 corresponding to monetary values in the electronic display region 30 may be manually increased or decreased by a user using the keypad buttons 39. The amount remaining on the stored value card may be preferably manually input using the keypad buttons 39 on the counter 20 by the user, however it will be recognized by the skilled artisan that one or more embodiments may include automatic balance updating at the point of sale or elsewhere. For example, an electronic signal may be received by the counter 20 corresponding to the amount remaining on the card and may change the amount shown in the electronic digital display 37 accordingly.

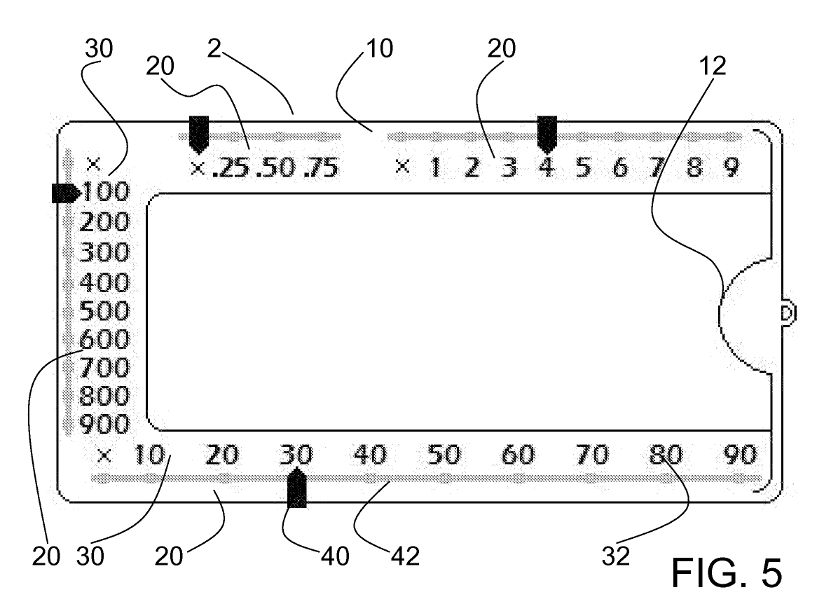

Now referring to FIG. 5, yet another embodiment of presenting the indicia 32 may include a plurality of counters 20, each counter 20 further including a display region 30, indicia 32, a pointer 40 and a track 42. In one embodiment the counters 20 may be of the slide type known in the art such that the pointer 40 may slide through multiple positions along the track 42, each position corresponding to one indicia 32. For example, plural counters 20 may be disposed on the top or bottom surface, 13 and 14, of the jacket 10. Each of the plural counters 20 may represent a different denomination of a monetary amount remaining on a stored value card, e.g., one counter 20 may represent cents wherein the indicia 32 is numbered x (equaling no value), 25, 50 and 75 cents (or as fractions of one dollar), another counter 20 may represent a dollar amount ranging from x (equaling no value) to 9 dollars, another counter 20 may represent a dollar amount as multiples of ten ranging from x (equaling no value), 10, 20, 30, 40, 50, 60, 70, 80 and 90 dollars, and yet another counter 20 may represent a dollar amount as multiples of one hundred ranging from x (equaling no value), 100, 200, 300, 400, 500, 600, 700, 800 and 900 dollars. The amount remaining on the stored value card may be preferably manually set by positioning the pointers 40 on the corresponding number indicia 32 on the counters 20 by the user, however it will be recognized by the skilled artisan that one or more embodiments may include automatic balance updating at the point of sale or elsewhere. Slide-type counters 20 as shown may include a ratchet or stop mechanism to retain the pointer 40 in position.

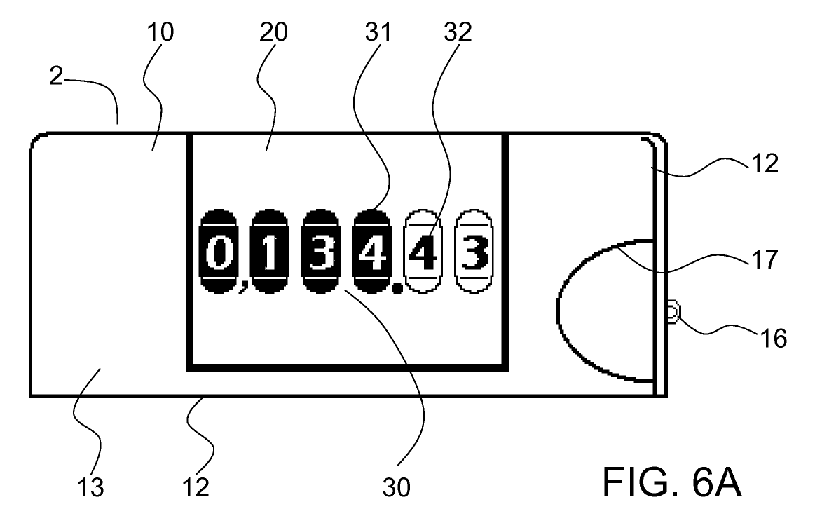

In one embodiment the jacket 10 and counter 20 may be sized and shaped to accommodate only a portion of an object. Now referring to FIGS. 6A and 6B, the jacket 10 and slot 17 may be smaller than a stored value card 70 with which it can be used. In this and other embodiments the slot 17 of the jacket 10 may receive only a portion of the card 70 through an accordingly modified opening 12, and holds the card securely, intentionally exposing a portion of the card, such as a magnetic strip 72 of the card 70. Such a configuration may permit the jacket 10 to remain on the card during use. As can be seen from FIG. 6B, a transit card or other stored value card 70 may be secured in jacket 10 such that the magnetic strip of the card is exposed, allowing a user to hold the device 2 while swiping the card 70 through a corresponding card reader.

In another embodiment the jacket 10 may be transparent to permit the user to view the card held within the device 2.

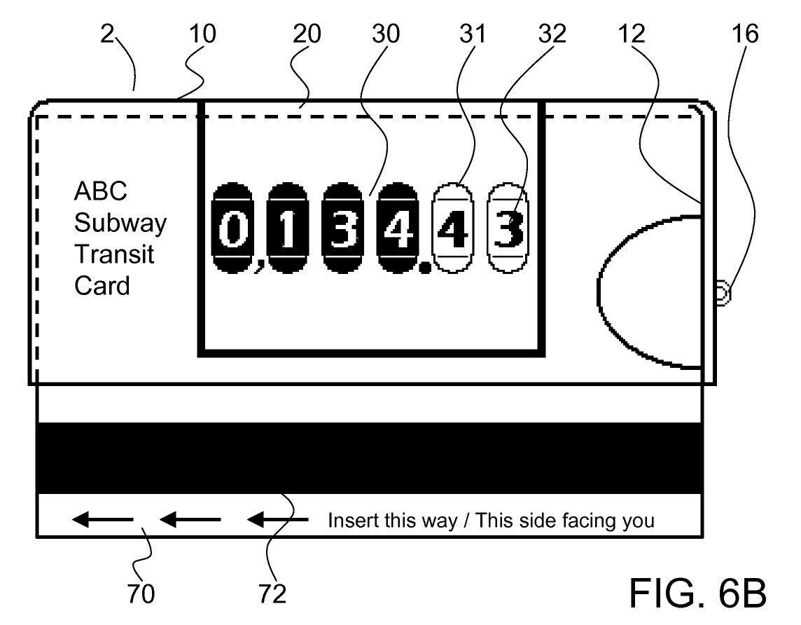

Now referring to FIG. 7 the bottom surface 14 may include a clip 15 for attaching the device 2 to a wallet, pocket, or the like. It is contemplated that the device 2 may include various other attachment means including but not limited to a hook and loop fastening strap, button, pin etc. for attaching to a belt, clothing, backpack, inside briefcase, pocketbook, hat, etc.

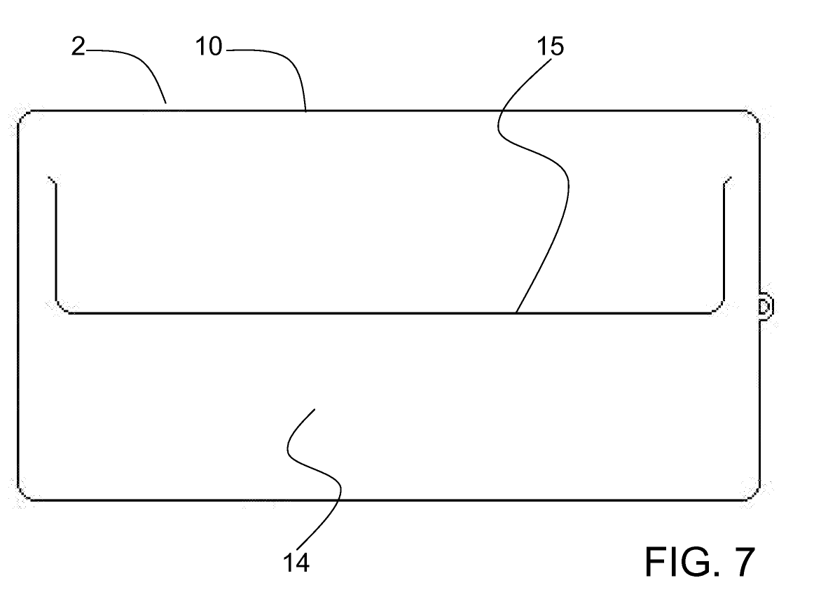

Now referring to FIG. 8 in another embodiment the device 2 may further include a cover 60. In this embodiment the cover 60 may function to conceal the display region 30 and to prevent inadvertent changing of the indicia 32 displayed through the opening 31. It is contemplated that the cover 60 may be attached to the jacket 10 or counter 20 by a hinge mechanism or other suitable means known to those skilled in the art.

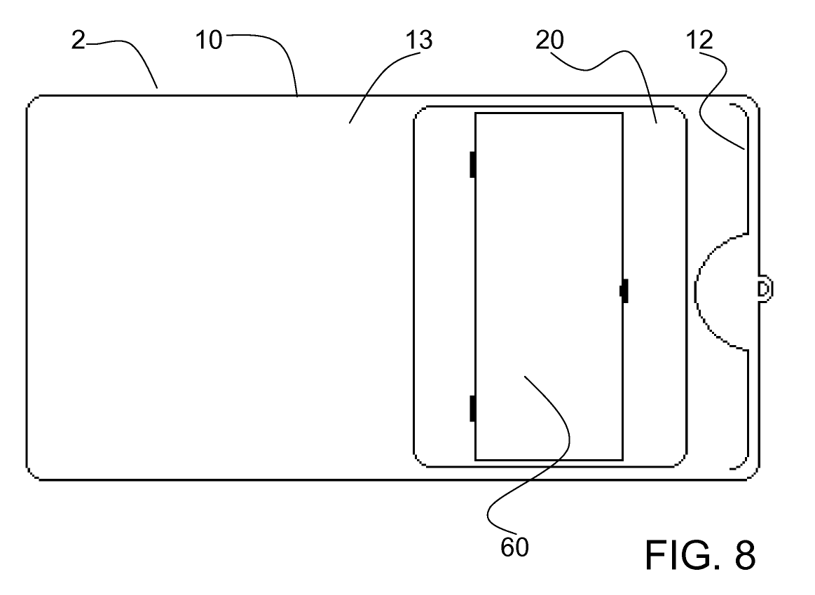

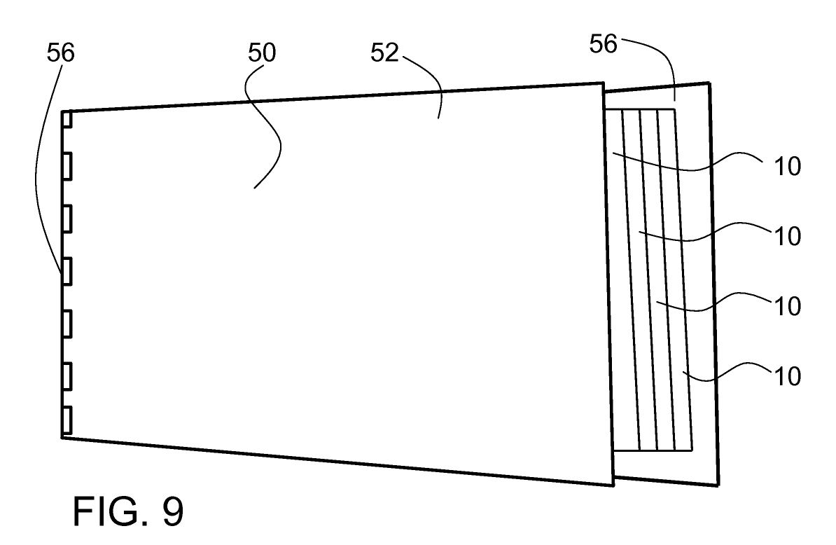

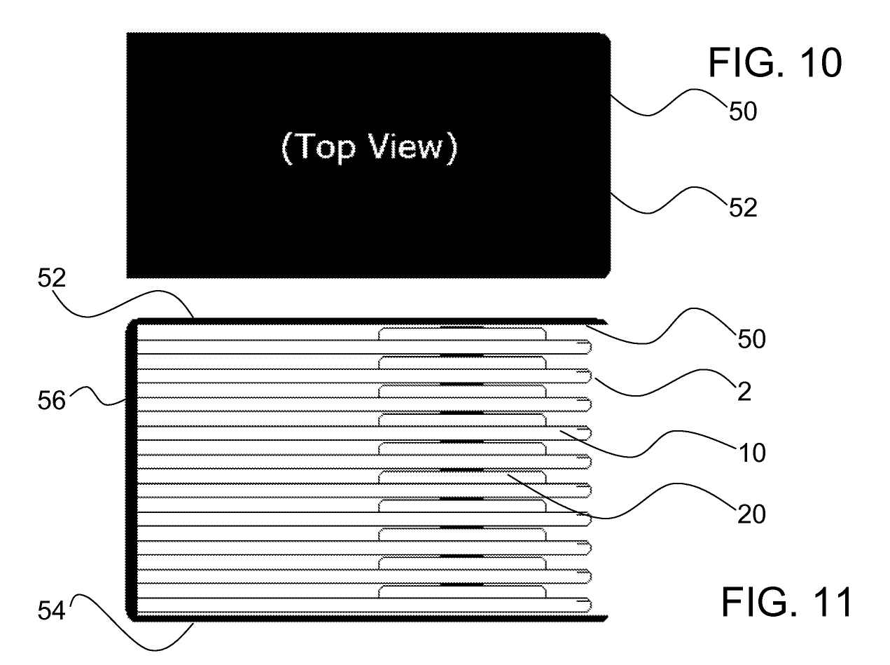

Now referring to FIGS. 9-11 in another embodiment, one or more devices 2 may be combined. For example, a plurality of devices 2 may be combined as a book 50 containing a plurality of jackets 10, one or more of such jackets 10 having a counter 20. In this form a collection of gift or other stored value cards may be stored conveniently. The book 50 may further include top and bottom cover pieces, 52 and 54, respectively, and a spine 56. The plurality of devices 2 may be attached to the spine 56 by various binding methods known to those skilled in the art. The top 52 and bottom 54 cover pieces, may be bound to the spine by various binding methods known to those skilled in the art. For example, a flexible material such as but limited to paper, plastic, fabric, silicone, latex or nylon, may be adhered to both the spine 56 and the device 2 and/or top and bottom cover pieces, 52 and 54, to form a flexible connection. In another embodiment a hinge mechanism, a spiral coil or the like may be used to bind the book 50.

In another embodiment, one or more stored value cards may be permanently integrated with the device 2. For example, the one or more stored value cards may be encased in the jacket 10. In such an embodiment the opening 12 would not be needed or present. The one or more stored valued cards may be completely covered by the jacket 10 or may be partially exposed such that the magnetic strip of the card is exposed, allowing a user to hold the device 2 while swiping the card 70 through a corresponding card reader.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. A stored value card holding device comprising:
at least one jacket comprising a slot and an opening; and
at least one counter device comprising one or more indicia,
wherein the at least one counter device is disposed on the at least one jacket.

2. The device according to claim 1, wherein the indicia comprise one or more series of numbers corresponding to monetary values.

3. The device according to claim 1, wherein the counter device comprises at least one display region that displays at least one of the indicia.

4. The device according to claim 3, wherein the counter device comprises an electronic display.

5. The device according to claim 4, wherein the counter device comprises a liquid crystal display.

6. The device according to claim 4, wherein the counter device comprises a light emitted display.

7. The device according to claim 4, wherein the counter device further comprises an electronic keypad having at least one button that functions to change the indicia displayed in the display region.

8. The device according to claim 7, wherein the electronic keypad comprises one button that functions to increase the indicia displayed in the display region and one button that functions to decrease the indicia displayed in the display region.

9. The device according to claim 3, wherein the counter device comprises one or more dials.

10. The device according to claim 3, wherein the at least one display region of the counter device comprises printed indicia and a pointer slidably situated in a track operable to position the pointer proximal to at least one of the printed indicia.

11. The device according to claim 2, wherein the counter device comprises a plurality of display regions, each display region corresponding to indicia of monetary values selected from the group consisting of cents, dollars, dollars in intervals of ten, dollars in intervals of hundreds and dollars in intervals of thousands.

12. The device according to claim 1, wherein the counter device further comprises a cover disposed proximal to and operable to conceal one or more display regions.

13. The device according to claim 1, wherein the jacket is dimensioned to receive a planar object.

14. The device according to claim 12, wherein the planar object is a card.

15. The device according to claim 1, wherein the jacket further comprises a device operable to attach the jacket to another object.

16. The device according to claim 1, wherein the jacket further comprises a hanger.

17. A device comprising:
a plurality of jackets each comprising a slot and an opening;
at least one counter device disposed on at least one of the plurality of jackets; and
wherein the plurality of jackets are contained in a unit.

18. The device according to claim 17, wherein the unit comprises a cover.

19. A stored value card device comprising:
at least one jacket;
at least one counter device comprising one or more indicia;
at least one stored value card;
wherein the at least one counter device is disposed on the at least one jacket, and wherein the at least one stored value card is integrated with the at least one jacket.
